(19) United States
(12) Patent Application Publication
(10) Pub. No.: US 2007/0019722 A1
(43) Pub. Date: Jan. 25, 2007

(54) Subband-video decoding method and device

(75) Inventors: Arnaud Bourge, Paris (FR); Eric Barrau, Puteaux (FR); Marion Benetiere, Rueil-Malmaison (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/558,716

(22) PCT Filed: May 27, 2004
(86) PCT No.: PCT/IB04/01807

§ 371 Date: Nov. 29, 2005

(30) Foreign Application Priority Data
Jun. 4, 2003 (EP) 03300025.8

(51) Int. Cl. H04N 11/04; H04N 11/02; H04B 1/66

(52) U.S. Cl. 375/240.11; 375/240.25; 375/240.29

(57) ABSTRACT

The invention relates to a video decoding method for the decompression of an input coded bitstream corresponding to an original video sequence that had been divided into successive groups of frames (GOFs) and coded by means of a subband video coding method. This decoding method comprises, on the one hand, sub-steps for the reconstruction of said first couple of frames of said current GOF, and, on the other hand, for the reconstruction of said (n−1) other couples of frames of the current GOF, sub-steps of decoding the current subbands by combining a previous sub-sampled portion and the new current sub-bitstream of the coded bitstream according to some specific rules, said decoding method being thus applied in order to reconstruct successively each couple of frames of the current GOF, up to the last one.

### FIELD OF THE INVENTION

The present invention generally relates to the field of video compression and decompression and, more particularly, to a video decoding method for the decompression of an input coded bitstream corresponding to an original video sequence that had been divided into successive groups of frames (GOFs) and coded by means of a subband video coding method comprising, in each GOF of said sequence, at least the following steps:
a temporal filtering step, performed on each successive couple of frames;
a spatial analysis step, performed on said filtered sequence;
an entropy coding step, performed on said analyzed, filtered sequence, the coded bitstream thus generated being organized in n sub-bitstreams that respectively correspond to the subbands useful at the decoding side to reconstruct the first couple of frames of the current GOF and, successively, the (n−1) other couples of frames.

The invention also relates to a decoding device for carrying out said decoding method.

### BACKGROUND OF THE INVENTION

From MPEG-1 to H.264, standard video compression schemes were based on so-called hybrid solutions (an hybrid video encoder uses a predictive scheme where each frame of the input video sequence is temporally predicted from a given reference frame, and the prediction error thus obtained by difference between said frame and its prediction is spatially transformed, for instance by means of a bi-dimensional DCT transform, in order to get advantage of spatial redundancies. A different approach, later proposed, consists in processing a group of frames (GOF) as a three-dimensional or 3D structure, also called [two-dimensional, or 2D+t] structure and spatio-temporally filtering said GOF in order to compact the energy in the low frequencies (as described for instance in “Three-dimensional subband coding of video”, C.I. Podilchuk and al., IEEE Transactions on Image Processing, vol. 4, n°2, February 1995, pp. 125-139). The introduction of a motion compensation step in such a 3D subband decomposition scheme then allows to improve the overall coding efficiency and leads to a spatio-temporal multiresolution (hierarchical) representation of the video signal thanks to a subband tree, as depicted in FIG. 1.

The 3D wavelet decomposition with motion compensation, illustrated in said FIG. 1, is similarly applied to successive groups of frames (GOFs). Each GOF of the input video, including in the illustrated case eight frames F1 to F8, is first motion-compensated (MC), in order to process sequences with large motion, and then temporally filtered (TF) using Haar wavelets (the dotted arrows correspond to a high-pass temporal filtering, while the other ones correspond to a low-pass temporal filtering). Three successive stages of decomposition are shown (L and H=first stage; LL and LH=second stage; LLL and LLH=third stage). The high frequency subbands of each temporal level (H, LH and LLH in the above example) and the low frequency subband(s) of the deepest one (LLL) are spatially analyzed through a wavelet filter. An entropy encoder then allows to encode the wavelet coefficients resulting from the spatio-temporal decomposition (for example, by means of an extension of the 2D-SPIHT, originally proposed by A. Said and W. A. Pearlman in “A new, fast, and efficient image codec based on set partitioning in hierarchical trees”, IEEE Transactions on Circuits and Systems for Video Technology, vol. 6, n°3, June 1996, pp. 243-250, to the present 3D wavelet decomposition, in order to efficiently encode the final coefficient bitplanes with respect to the spatio-temporal decomposition structure).

However, all the 3D subband solutions suffer from the following drawback: since an entire GOF is processed at once, all the pictures in the current GOF have to be stored before being spatio-temporally analyzed and encoded. The problem is the same at the decoder side, where all the frames of a given GOF are decoded together. A so-called “low memory” solution to said problem is described in an international patent application filed by the applicant and published with the No. WO2004/004355 (PHFR020065). According to this “low-memory” solution, a progressive branch-by branch reconstruction of the frames of a GOF of the sequence is performed instead of a reconstruction of the whole GOF at once. As illustrated in FIG. 2 (in the case of a GOF of eight frames for the sake of simplicity of the figure) where the frames F1 to F8 of the GOF are grouped into four couples of frames C0 to C3, the whole set of transmitted subbands is surrounded by a black line, and the generated coded bitstream is indicated at the bottom of said FIG. 2 (the references 21 and 22 designate an entropy coder and an arithmetic coder allowing to obtain said coded bitstream). The operations performed according to said solution are then the following. The part of the coded bitstream corresponding to the current GOF is decoded a first time, but only the coded part that, in said bitstream, corresponds to the first couple of frames C0 (the two first frames F1 and F2)—i.e. the subbands H0, LH0, LLL0, LLH0—is, in fact, stored and decoded. When the first two frames F1, F2 have been decoded, the first H subband, referenced H0, becomes useless and its memory space can be used for the next subband to be decoded. The coded bitstream is therefore read a second time, in order to decode the second H subband, referenced H1, and the next couple of frames C1 (F3, F4). When this second decoding step has been performed, said subband H1 becomes useless and the first LH subband too (referenced LH0). They are consequently deleted and replaced by the next H and LH subbands (respectively referenced H2 and LH1), that will be obtained thanks to a third decoding of the same input coded bitstream, and so on for each couple of frames of the current GOF.

This multipass decoding solution, comprising an iteration per couple of frames in a GOF, is detailed with reference to FIGS. 3 to 6. During the first iteration, the coded bitstream CODB received at the decoding side is decoded by an arithmetic decoder 31, but only the decoded parts corresponding to the first couple of frames C0 are stored, i.e. the subbands LLL0, LLH0, LH0 and H0 (see FIG. 3). With said subbands, the inverse operations (with respect to those illustrated in FIG. 1) are then performed:
the decoded subbands LLL0 and LLH0 are used to synthesize the subband LL0;
said synthesized subband LL0 and the decoded subband LH0 are used to synthesize the subband L0;
said synthesized subband L0 and the decoded subband H0 are used to reconstruct the two frames F1, F2 of the couple of frames C0.

When this first decoding step is achieved, a second one can begin. The coded bitstream is read a second time, and only the decoded parts corresponding to the second couple of frames C1 are now stored: the subbands LLL0, LLH0, LH0 and H1 (see FIG. 4). In fact, the dotted information of FIG. 4 (LLL0, LLH0, LL0, LH0) can be reused from the first decoding step (this is especially true for the bitstream information after the arithmetic decoding, because buffering this compressed information is not really memory consuming). With these subbands, the following inverse operations are now performed:
the decoded subband LLL0 and LLH0 are used to synthesize the subband LL0;
said synthesized subband LL0 and the decoded subband LH0 are used to synthesize the subband L1;
said synthesized subband L1 and the decoded subband H1 are used to reconstruct the two frames F3, F4 of the couple of frames C1.

When this second decoding step is achieved, a third one can begin similarly. The coded bitstream is read a third time, and only the decoded parts corresponding to the third couple of frames C2 are now stored: the subbands LLL0, LLH0, LH1 and H2 (see FIG. 5). As previously, the dotted information of FIG. 5 (LLL0, LLH0) can be reused from the first (or second) decoding step. The following inverse operations are performed
the decoded subbands LLL0 and LLH0 are used to synthesize the subband LL1;
said synthesized subband LL1 and the decoded subband LH1 are used to synthesize the subband L2;
said synthesized subband L2 and the decoded subband H2 are used to reconstruct the two frames F5, F6 of the couple of frames C2.

When this third decoding step is achieved, a fourth one can begin similarly. The coded bitstream is read a fourth time (the last one for a GOF of four couples of frames), only the decoded parts corresponding to the fourth couple of frames C3 being stored: the subbands LLL0, LLH0, LH1 and H3 (see FIG. 6). Similarly, the dotted information of FIG. 6 (LLL0, LLH0, LL1, LH1) can be reused from the third decoding step. The following inverse operations are performed:
the decoded subbands LLL0 and LLH0 are used to synthesize the subband LL1;
said synthesized subband LL1 and the decoded subband LH1 are used to synthesize the subband L3;
said synthesized subband L3 and the decoded subband H3 are used to reconstruct the two frames F7, F8 of the couple of frames C3.

This procedure is repeated for all the successive GOFs of the video sequence. When decoding the coded bitstream according to this procedure, at most two frames (for example: F1, F2) and four subbands (with the same example: H0, LH0, LLH0, LLL0) have to be stored at the same time, instead of a whole GOF. A drawback of that low-memory solution is however its complexity: the same input bitstream has to be decoded several times (as many times as the number of couples of frames in a GOF) in order to decode the whole GOF.

A solution to this problem is described in an international patent application filed by the applicant and published with the No. WO 2004/008771 (PHFR020073). In this document, the following principle is applied: the input bitstream is re-organized at the coding side in such a way that the bits necessary to decode the first two frames are at the beginning of the bitstream, followed by the extra bits necessary to decode the second couple of frames, followed by the extra bits necessary to decode the third couple of frames, etc. This solution is illustrated in FIG. 7, in the case of n=3 decomposition levels, but said solution is obviously applicable whatever the number n of these levels. At the output of the entropy coder 21, the available bits b are now organized in bitstreams BS0, BS1, BS2, BS3 that respectively correspond to:
the subbands LLL0, LLH0, LH0, H0 useful to reconstruct at the decoding side the couple of frames C0;
the extra subband H1, useful (in association with the subbands LLL0, LLH0, LH0 already put in the bitstream) to reconstruct the couple of frames C1;
the extra subbands LH1, H2 useful (in association with the subbands LLL0, LLH0 already put in the bitstream) to reconstruct the couple of frames C2;
the extra subband H3, useful (in association with the subbands LLL0, LLH0, LH1 already put in the bitstream) to reconstruct the couple of frames C3.

As indicated, these elementary bitstreams BS0 to BS3 are then concatenated in order to constitute the global bitstream BS which will be transmitted. In said bitstream BS, it does not mean that the part BS1 (for example) is sufficient to reconstruct the frames F3, F4 or even to decode the associated subband H1. It only means that with the part BS0 of the bitstream, the minimum amount of information needed to decode the first two frames F1, F2 (couple CO) is available, then that with said part BS0 and the part BS1, the following couple of frames C1 can be decoded, then that with said parts BS0 and BS1 and the part BS2, the following couple of frames C2 can be decoded, and then that with said parts BS0, BS1, BS2 and the part BS3, the last couple of frames C3 can be decoded (and so on, in the general case of 2ⁿ couples of frames in a GOF).

With this re-organized bitstream, the multiple-pass decoding solution as previously described is no longer necessary. The coded bitstream has been organized in such a way that, at the decoding side, every new decoded bit is relevant for the reconstruction of the current frames. An implementation of this video coding method is illustrated in the flowchart of FIGS. 8 to 10. As illustrated in FIG. 8 with the references 81 to 85, the current GOF (81) comprises N=2ⁿ frames A0, A1, A2, . . . , A(N−1) which are organized (step 82) in successive couples of frames (or COFs) C0=(A0, A1), C1=(A2, A3), . . . , C((N/2)−1)=(A(N−2), A(N−1)). At the first temporal level TL1, the temporal filtering step TF is first performed on each couple of frames (step TFCOF 84), which leads to outputs TF(C0)=(L[1,0], H[1,0]), TF(C1)=(L[1,1], H[1,1]), . . . , TF(C((N/2)−1))=(L[1,((N/2)−1)], H[1, ((N/2)−2)]), in which L[.] and H[.] designate the low frequency and high frequency temporal subbands thus obtained. An updating step 85 (UPDAT) then allows to store the logical indication of a connection between each couple of frames C0, C1, etc. . . , and each subband that contains some information on the concerned couple of frames. These connections between a given couple of frames and a given subband is indicated by logical relations of the type:

L[1,0]₁₃IsLinkedWith₁₃CO=TRUE

H[1,0]₁₃IsLinkedWith₁₃CO=TRUE

L[1,1]₁₃IsLinkedWith₁₃C1=TRUE

H[1,1]₁₃IsLinkedWith₁₃C1=TRUE

etc.

(said logical relations have been previously initialized in the step INIT 83: “for all temporal subbands S, for all couples C, S₁₃IsLinkedWith₁₃C=FALSE”).

As illustrated in FIG. 9 with the references 91 to 98, the subband decomposition can then take place, between the operation 91 called jt=1 (=beginning of the first temporal decomposition level) and the operation 95 called jt=jt+1 (=control of the following temporal decomposition level, according to the feedback connection indicated in FIG. 9 and activated only if, after a test 96, jt is lower than a predetermined value jt₁₃max correlated to the number of frames within each GOF). At each temporal decomposition level, new couples K are formed (step KFORM 92) with the L subbands, according to the relations:

K0=(L[jt, 0], L[jt, 1])

K1=(L[jt, 2], L[jt, 3])

. . . . . . . . .

and a temporal filtering step TF is once more performed (step TFILT 93) on these new K couples:

TF(K0)=(L[jt+1, 0], H[jt+1, 0])

TF(K1)=(L[jt+1, 1], H[jt+1, 1])

. . . . . . . . .

An updating step 94 (UPDAT) is then provided for establishing a connection between each of the subbands thus obtained and the original couples of frames, i.e. for determining if a given subband will be involved or not at the decoding side in the reconstruction of a given couple of frames of the current GOF. At the end of the temporal decomposition, the following subbands:

L(jt₁₃max, n), for n=0 to N/2^{jt},

H(jt, n), for jt=1 to jt₁₃max and n=0 to N/(2^{jt}), which correspond to the subbands to be transmitted, are extracted (step EXTRAC 97). This ensemble is called T in the following part of the description. A spatial decomposition of said subbands is then performed (step SDECOMP 98), and the resulting subbands are finally encoded according to the flowchart of FIG. 10, in such a way that the output coded bitstream BS (such as shown in FIG. 7) is finally obtained.

After an entropy coding step 110 (ENC), a control (step BUDLEV 111) of the bit budget level is performed at the output of the encoder. If the bit budget is not reached, the current output bit b is considered (step 112), n is initialized (step 113), and a test 115 is performed on a considered subband S (step 114) from the ensemble T. If b contains some information about S (step BINFS 115) and if S is linked with the couple Cn (step SLINKCN 116), the concerned bit b is appended (step BAPP 117) to the bitstream BSn (n=0, 1, 2, 3 in the example previously given with reference to FIGS. 1 to 7) and the following output bit b is considered (i.e. a repetition of the steps 111 to 117 is carried out). If b does not contain any information about S, or if S is not linked with the couple Cn, the next subband S is considered (step NEXTS 118). If all subbands in T have not been considered (step ALLS 119), the operations (steps 115 to 118) are further performed. If all said subbands have been parsed, the value of n is increased by one (step 120), and the operations (steps 114 to 120) are further performed for the next original couple of frames (and so on, up to the last value of n). At the output of the coding step 110, if the bit budget has been reached, no more output b is considered.

Finally, when all output bits have been considered or if the bit budget has been reached (step 111), the whole coding step is considered as achieved and the individual bitstream BSn obtained are concatenated (step CCAT 130) into the final bitstream BS (from n=0 to its maximum value). At the decoding side, the decoding step is performed as now explained with reference to FIG. 11, where “state 0” (1, 2, . . . , n) means that the functioning of the entropy encoder is constrained by the reconstruction of a unique couple, C0 in the present case (C0, C1, C2, . . . , Cn in the general case) with n=0 to 3 in the illustrated example. In practice, when a bit b of the coded bitstream is received and decoded, it is interpreted as containing some pixel significance (or set significance) information related to a pixel in a given spatio-temporal subband (or to several pixels in a set of such subbands). If none of these subbands contributes to the reconstruction of the current couple of frames Cn (C0 in the illustrated example), the bit b has to be re-interpreted, the entropy decoder DEC jumping to its next state until b is interpreted as contributing to the reconstruction of Cn (C0 in the present case). And so on for the next bit, until the current sub-bitstream is completely decoded.

The described functioning of the decoding of the first couple C0 (state “0”) is therefore fairly straightforward with the above explanations, and FIG. 11 shows clearly the 3D subband spatio-temporal synthesis of the couple of frames C0: at the third synthesis level jt=3, the subbands LLL0 and LLH0 are combined (dotted arrows) with motion compensation (illustrated by the curved arrows), in order to synthesize the appropriate subband LL0 of the second decomposition level jt=2, said subband LL0 and the subband LH0 are in turn combined, with motion compensation, in order to synthesize the appropriate subband L0 of the first decomposition level jt=1, and said subband L0 and the subband H0 are in turn combined, with motion compensation, in order to synthesize the concerned couple of frames C0 (jt=0). More generally, if the size of the complete GOF is N=2ⁿ, (n+1) temporal subbands (one low frequency temporal subbands and n high frequency temporal subbands) have to be decoded and (n−1) low frequency temporal subbands have to be reconstructed, which corresponds to a noticeable reduction of memory space with respect to the case of the decoding and reconstruction of the entire GOF at once. In the illustrated case, at each step, the reconstructed low frequency subband of the lower temporal level (e.g. LL0, at jt=2) is written over the previous one (e.g. LLL0, at jt=3), that gets lost.

With such a solution, there are never more than (n+1) temporal subbands stored in memory. However, some of the lost subbands are nevertheless useful in order to reconstruct the next couple of frames and have therefore to be synthesized again, which leads to some increased complexity, especially when motion compensation is involved.

### SUMMARY OF THE INVENTION

It is therefore a first object of the invention to propose a decoding method allowing to avoid this drawback.

To this end, the invention relates to a video coding method such as defined in the introductory part of the description and which is further characterized in that it comprises:
on the one hand, for the reconstruction of said first couple of frames of said current GOF, the sub-steps of:
   decoding each current bit b of the current sub-bitstream of said coded bistream;
   interpreting each decoded bit as containing a significance information related to one or several pixels in a given spatio-temporal subband or a set of such subbands;
   testing the contribution of said subband(s) to the reconstruction of said first couple of frames and storing only the decoded bits that contain information related to other frames than the frames of the first couple of frames, said stored bits forming a so-called sub-sampled portion of bitstream;
   reconstructing said first couple of frames;
on the other hand, for the reconstruction of said (n−1) other couples of frames of the current GOF, the sub-step of decoding the current subbands by combining the previous sub-sampled portion and the new current sub-bitstream of said coded bitstream according to the following rules:
   the decoding sub-step of said previous sub-sampled portion is only carried out in order to retrieve the associated information that concerns the newly decoded subband(s);
   when decoding a bit B, if it is interpreted as containing information exclusively about the newly decoded subband(s), it is stored and replaced, by means of a switching operation, by the next bit in the new current sub-bitstream of the coded bitstream;
   when continuing the decoding of the bits in said new current sub-bitstream, it is switched back to the previous sub-sampled portion and its last non-decoded stored bit as soon as a bit of said new current sub-bitstream is interpreted as containing information about other subbands than the newly decoded ones;
   storing simultaneously the next sub-sampled portion of bitstream, which is a combination of the bits of said previous sub-sampled portion and said new current sub-bitstream and does not include the bits that will not be needed any longer;
      said decoding method being thus applied in order to reconstruct successively each couple of frames of the current GOF, up to the last one.

It is also an object of the invention to propose a decoding device for the implementation of said decoding method.

### BRIEF DESCRIPTION OF DRAWINGS

The present invention will now be described, by way of example, with reference to the accompanying drawings in which:

FIG. 1 illustrates a 3D subband decomposition, performed in the present case on a group of eight frames;

FIG. 2 shows, among the subbands obtained by means of said decomposition, the subbands that are transmitted and the bitstream thus formed;

FIGS. 3 to 6 illustrate, in a decoding method already proposed by the applicant, the operations iteratively performed for decoding the input coded bitstream;

FIG. 7 illustrates the basic principle of a video coding method previously proposed by the applicant;

FIGS. 8 to 10 show respectively the three successive parts of a flowchart that illustrates an implementation of the video coding method illustrated in FIG. 7;

FIG. 11 illustrates a decoding method corresponding to the coding method of FIGS. 7 to 10;

FIG. 12 illustrates the fact that, when a couple of frames has been reconstructed in order to be displayed, some subbands are not needed anymore;

FIG. 13 shows how a sub-sampled bitstream of the portions of bitstream already scanned can be obtained;

FIG. 14 illustrates how a previous sub-sampled portion (BS′0) and the current portion BS1 of the transmitted bitstream BS are combined to decode the current subbands and to reconstruct the next couple of frames;

FIGS. 15 and 16 illustrate how to combine a previous sub-sampled portion and the current portion of bitstream and to construct the next sub-sampled bitstream.

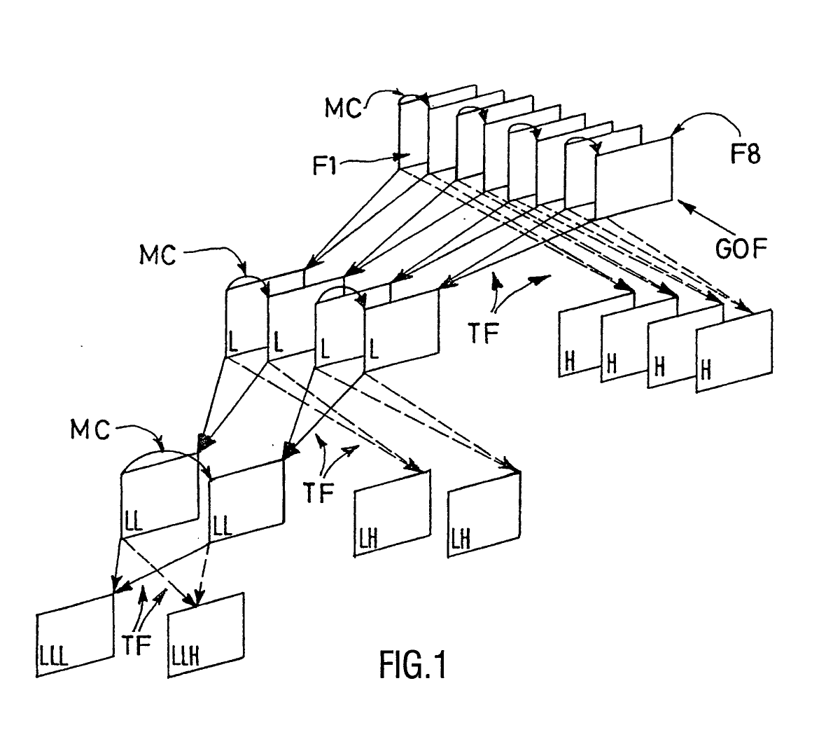

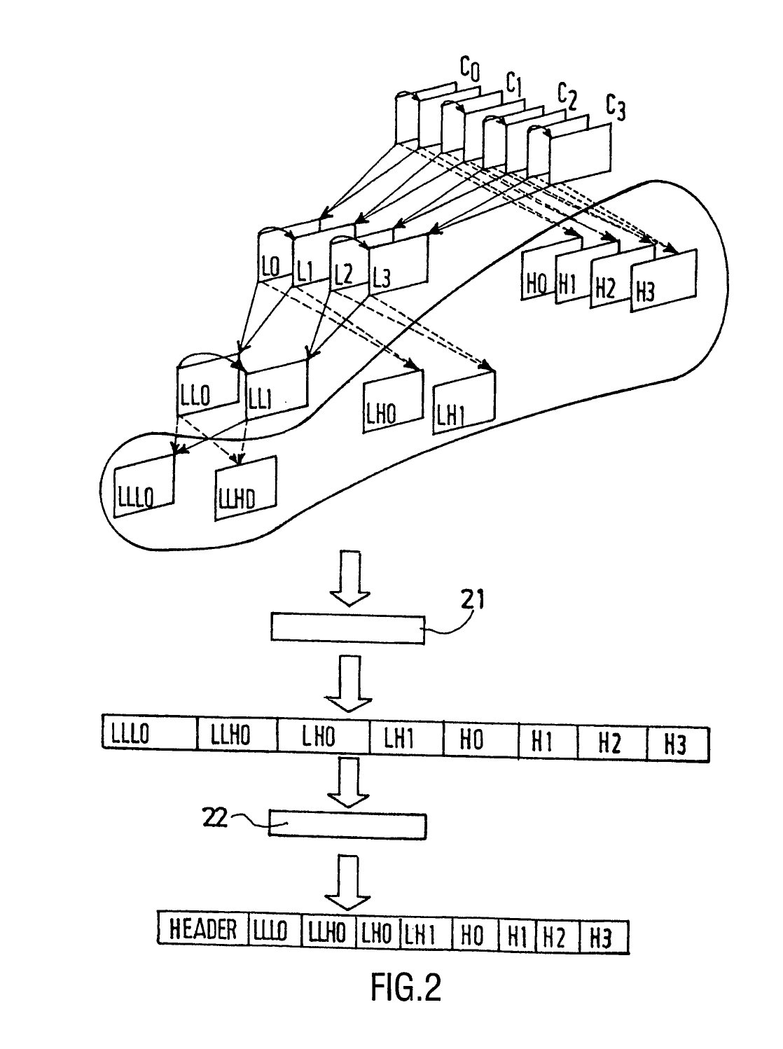

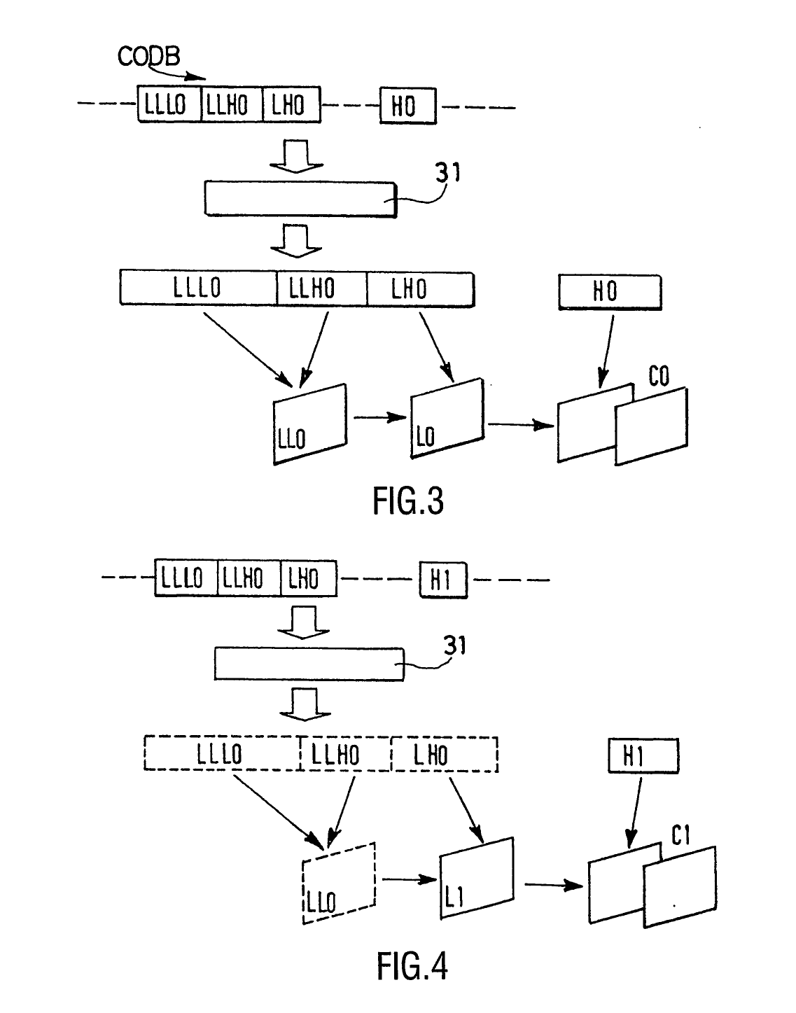

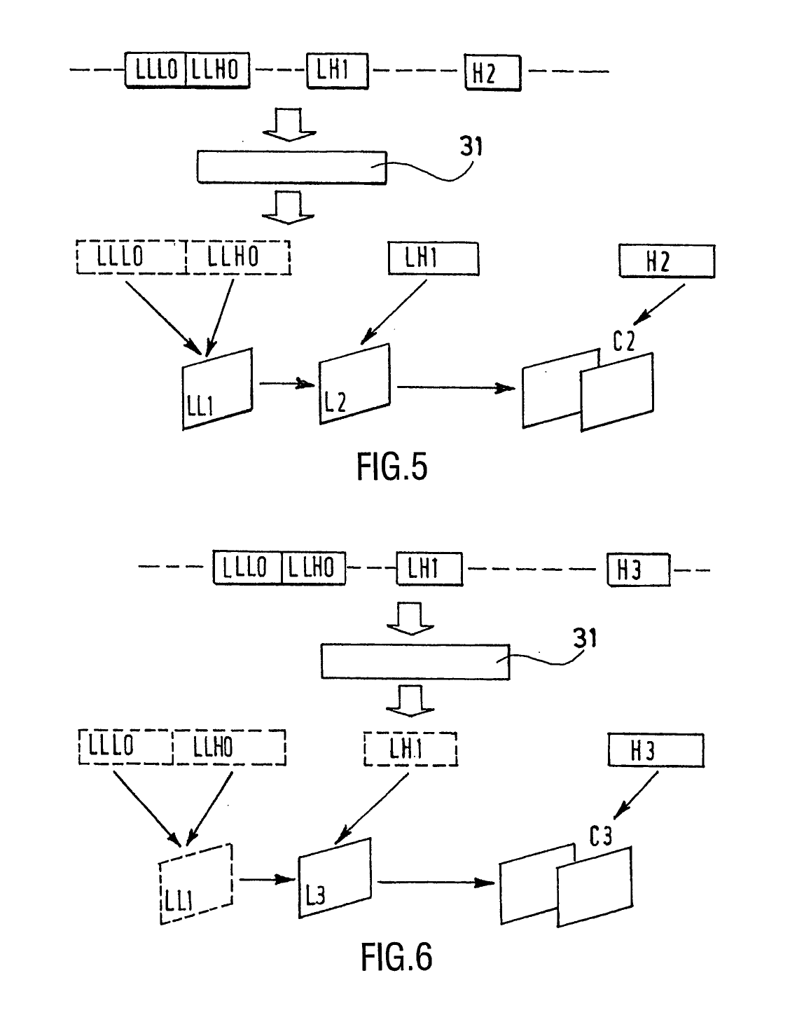

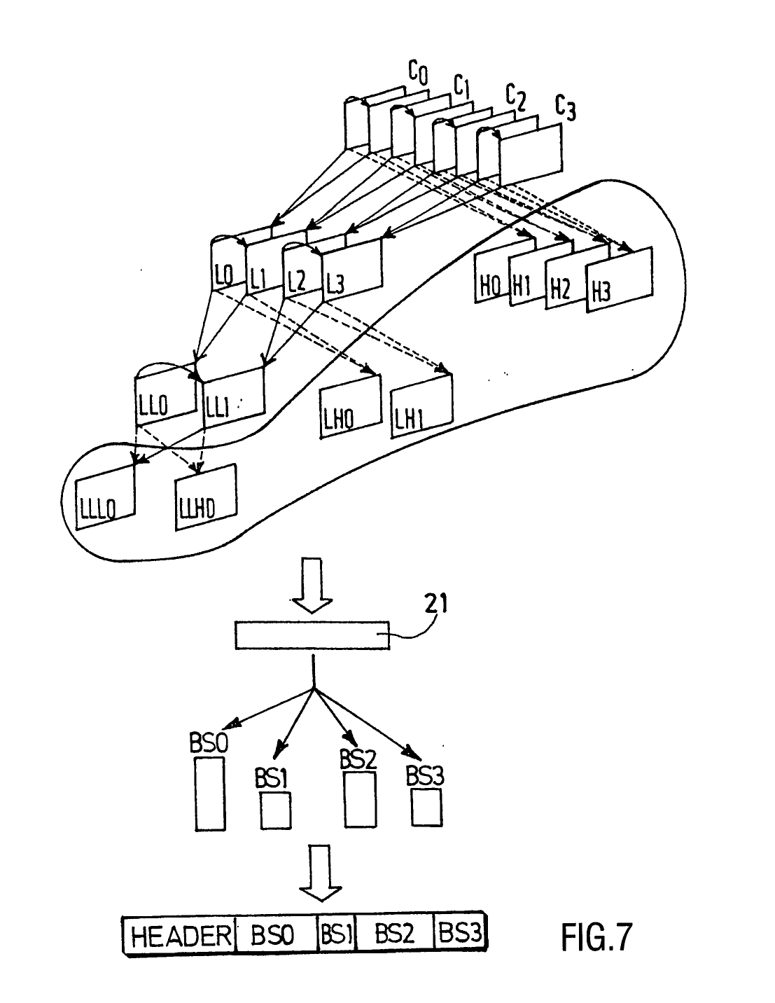

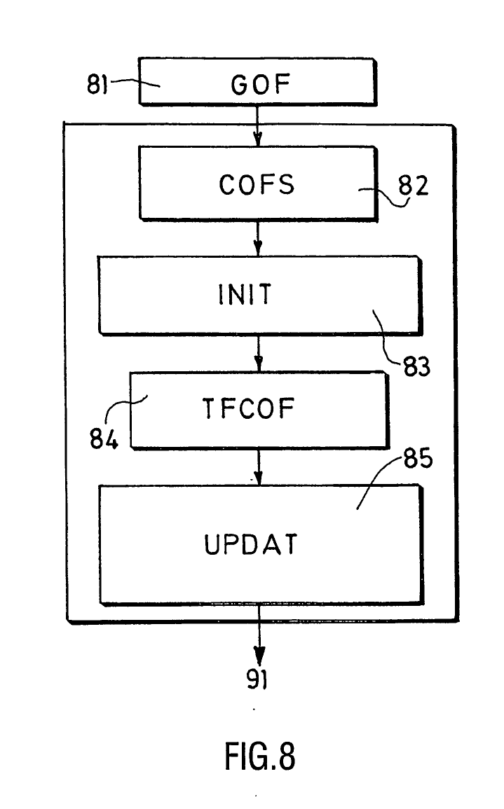

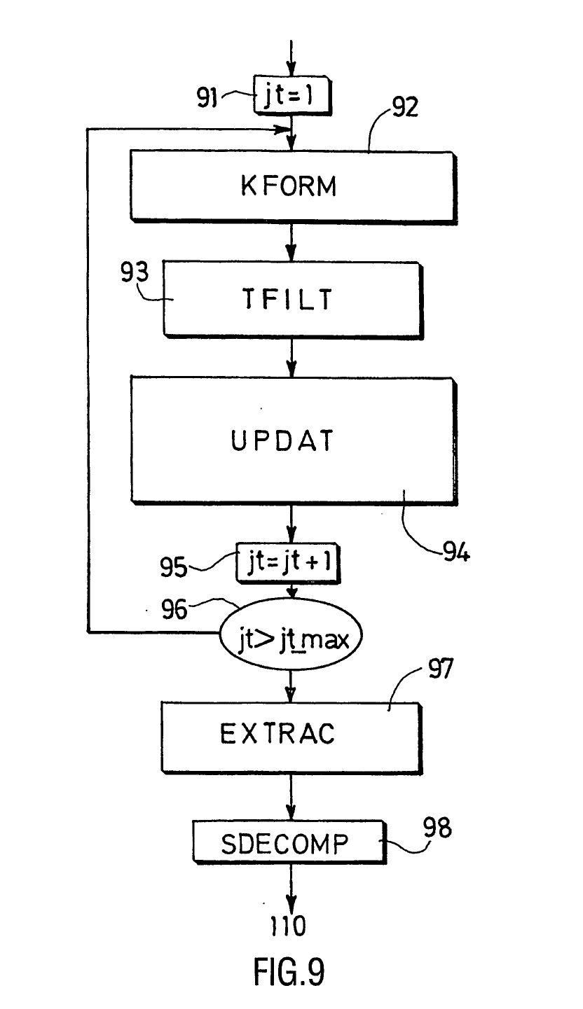

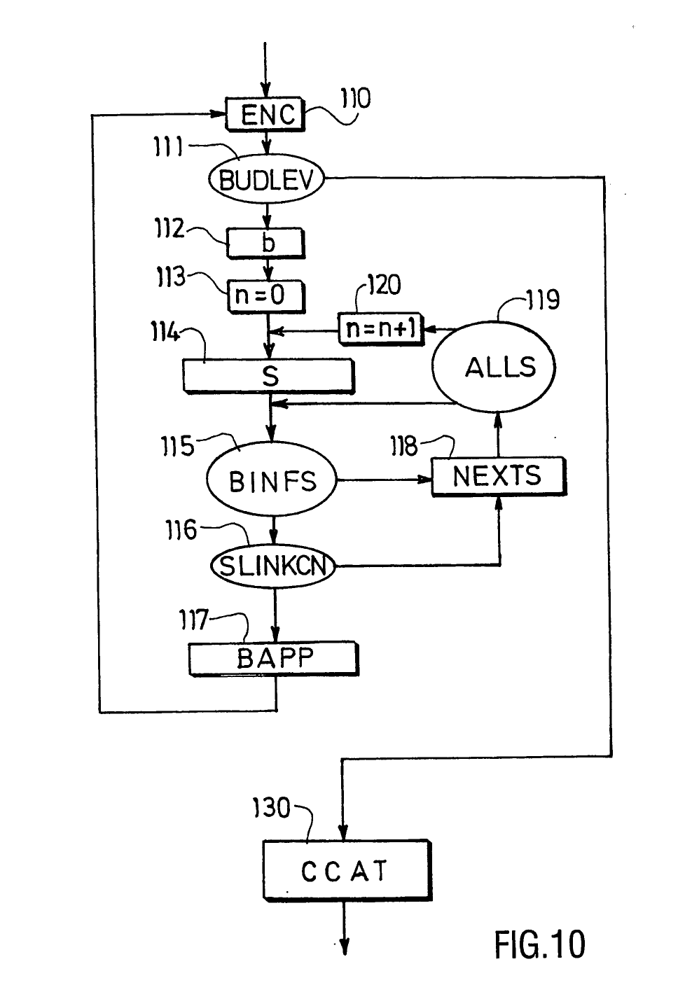

### DETAILED DESCRIPTION OF THE INVENTION

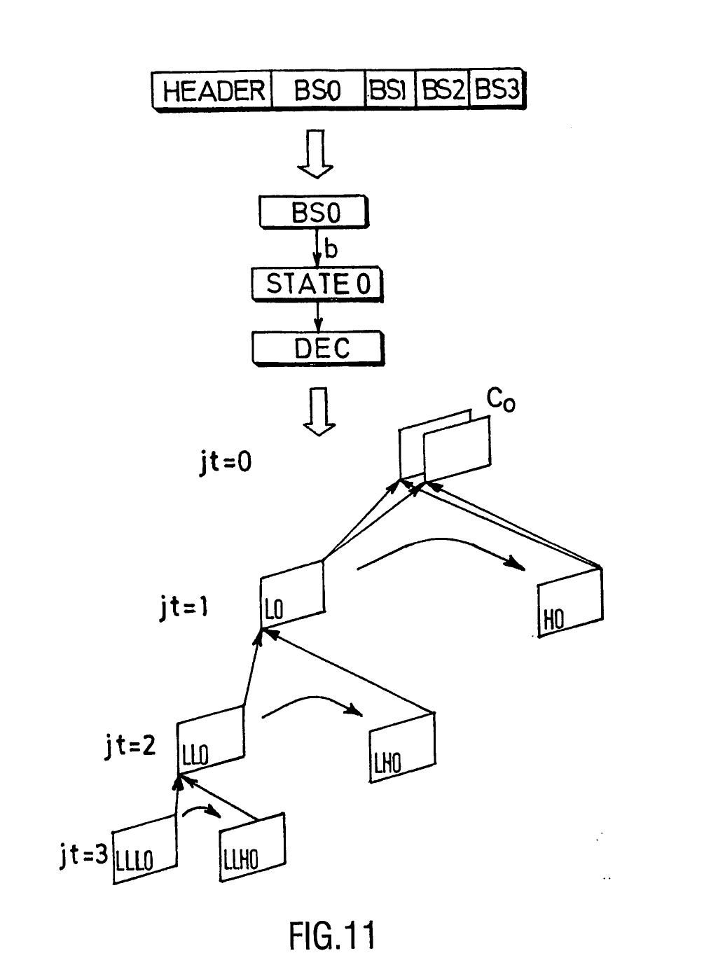

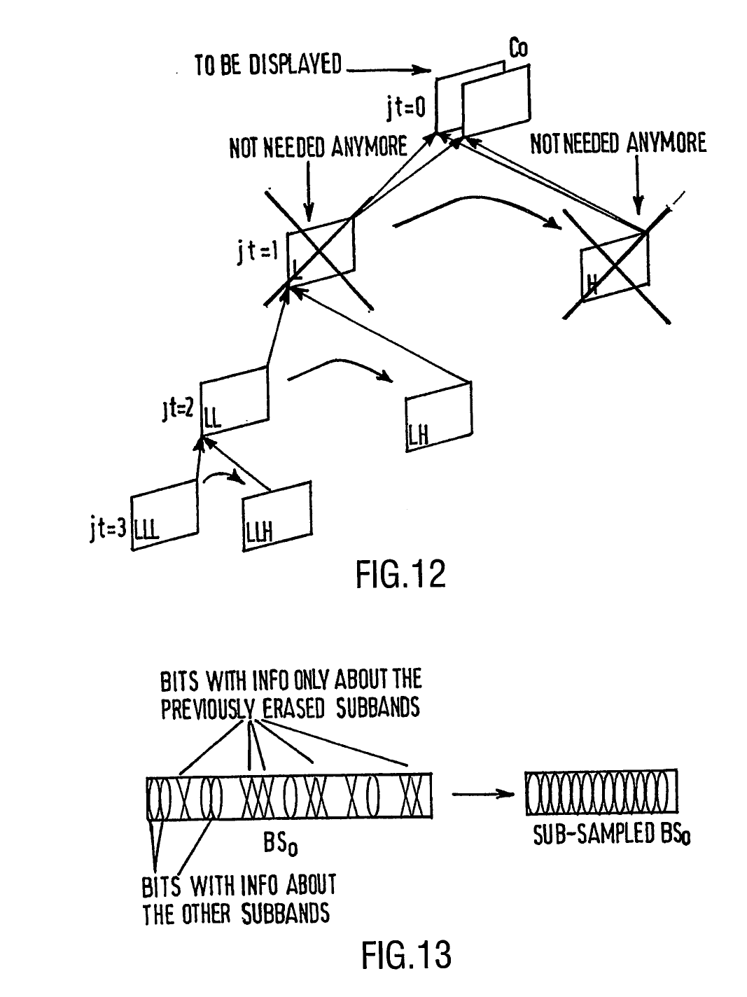

When the frames of a couple (CO, in the example of FIG. 11) are reconstructed, the corresponding two temporal subbands L0, H0 of the first temporal decomposition level are not needed anymore, as illustrated in FIG. 12. The corresponding memory space can be allocated to the two temporal subbands (L and H) that will allow the reconstruction of the next couple of frames (L1 and H1, in the case of the couple C1): L1 is synthesized from LL0 and LH0 (that were kept) at the next temporal level, and H1 has to be decoded from the next portion of the bistream BS1. However, this portion of bitstream cannot be decoded by itself, since it needs some elements from the previous portions.

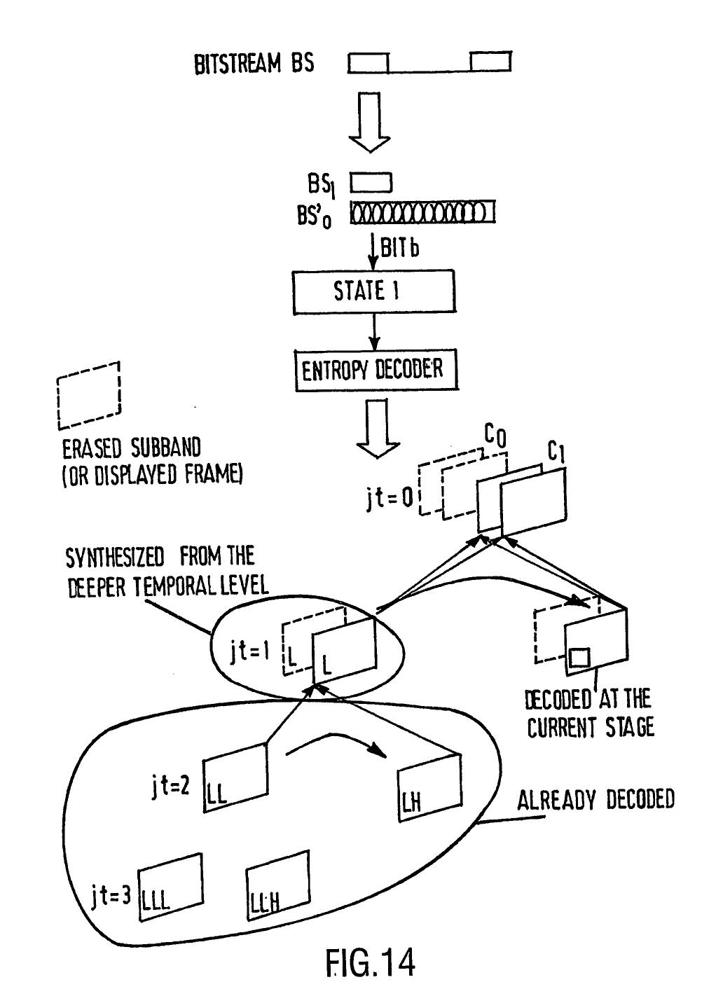

The principle of the invention is then the following: it is proposed to keep a so-called “sub-sampled” version of the previous portions, that only contains those bits that are still needed to correctly decode the current bitstream: in practice, it means that each decoded bit b is stored in a buffer if the information it contains is also related to frames that have not be reconstructed yet. As illustrated in FIG. 13, the previous portion, BS0 in the present case, contains bits with information only about the previously erased subbands (they are designated with crosses in FIG. 13) and bits with information about the other subbands too: the latter ones were stored, in order to be combined with the current portion of the bitstream to decode the current subbands. The following description indicates, with reference to FIG. 14, how such a previous portion and the current portion of the transmitted bitstream are combined to decode said current subbands. In FIG. 14, the concerned portions to be combined in order to decode the new subband H are designated by the references BS′0 and BS1.

First, the sub-sampled bitstream BS′0 is decoded bit by bit as if it was BS0, but with the rules of “state 1” (it is recalled that “state n” means that the usual functioning of the entropy encoder is constrained by the reconstruction of a unique couple Cn: in practice, when a bit b is decoded, it is interpreted as containing some pixel significance information—or set significance information—related to a pixel in a given spatio-temporal subband—or, respectively, to several pixels in a set of such subbands—said bit b having to be re-interpreted if none of these subbands contributes to the reconstruction of the current couple of frames Cn, and the entropy decode consequently jumping to its next state until b is interpreted as contributing to the reconstruction of Cn). The main differences are however:
BS′0 follows the rules of “state 1”, and a bit b cannot be interpreted as belonging to a subband that has been previously erased or to a set that exclusively contains such subbands (“state 0”);
the decoding of BS′0 is useful just to retrieve at each bitplane the set significance information that concerns the newly decoded subband(s) (the pixel significance—or unsignificance—information having not to be physically written since the corresponding subbands have already been decoded and stored);
when decoding a bit b that is interpreted by the decoder as containing information exclusively about the newly decoded subbands, this bit b is stored for the moment, by switching, replaced by the next bit of the new portion BS1 (by the first bit of BS1 if it is the first switch).

Thanks to this switch, the bits of the sub-sampled bitstream BS′0 can never be written in the newly decoded subbands. Similarly, continuying the decoding of the bits in BS1, it is switched back to BS′0 and its last non-decoded bit (the one that has been stored) as soon as a bit is interpreted as containing information about other subbands than the newly decoded ones. To summarize, it can be said that BS′0 is decoded using an intermediary state S′ which is the intersection of “state 0” and “state 1”, and that BS1 is decoded using the remaining of “state 1” (a switch occurring as soon as a bit in one portion is interpreted as belonging to the state of the other one).

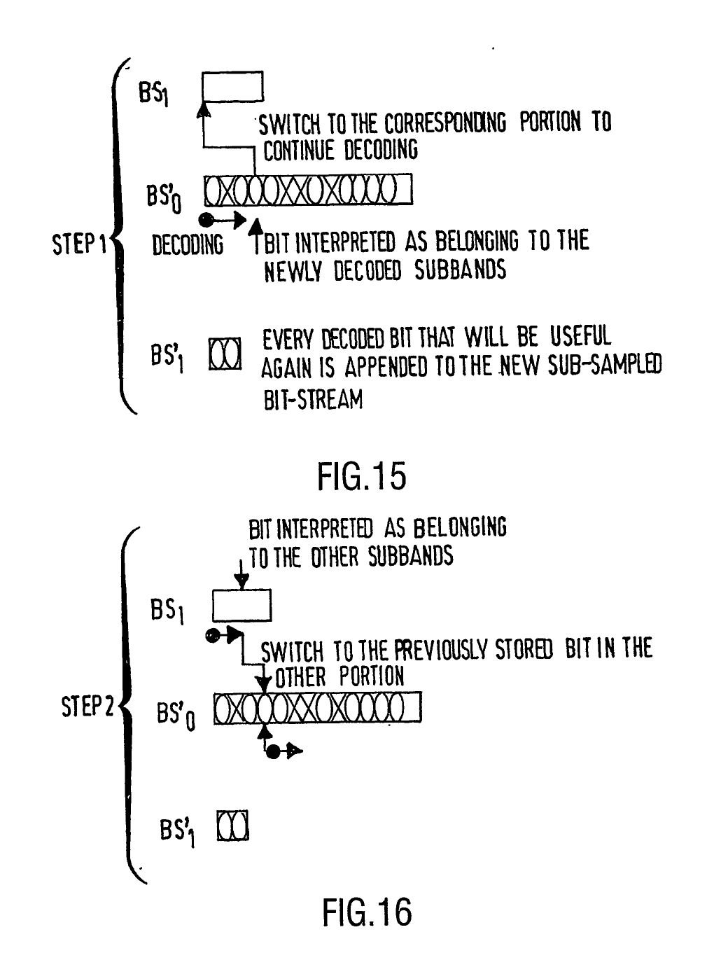

The next sub-sampled bitstream is generated simultaneously: it is a combination of BS′0 and BS1 that follows the switches and that does not include those bits that will not be needed anymore. This is explained with reference to FIGS. 15 and 16, which show how to combine two portions and to construct the newly sub-sampled bitstream:

(a) step 1 (FIG. 15):
the previous sub-sampled bitstream BS′0 being decoded, one of its bits is interpreted as belonging to the newly decoded subbands: there is then a switch to the appropriate portion of the current portion BS1 of the bitstream, in order to continue the decoding process;
in the same time, every decoded bit that will be useful again is appended to the newly sub-sampled bitstream BS′1;

(b) step 2 (FIG. 16): the current portion BS1 being now decoded, one of its bits is interpreted as belonging to the other subbands: there is then a switch to the appropriate (previously stored) bit in the previously sub-sampled bitstream BS′0.

This process continues similarly between the steps 1 and 2. It can be noted that, in the example of FIG. 6 with the two bitstreams BS′0 and BS1, the current bitstream BS1 contains information only about a high frequency subband of the first temporal decomposition level. None of its bits has therefore to be saved, and thus the newly sub-sampled bitstream BS′1 is only a sub-sampled version of BS′0. However, in the general case, for the next portions of bitstream, BS′(n+1) can be a real sub-sampled version of a combination of both BS′(n) and BS(n+1). After the couple C1 is synthesized, several subbands (more precisely, all the subbands at levels jt=1 and 2) are not useful anymore and can be lost: when decoding the next bitstream portion, other subbands will replace them in order to reconstruct the next couple of frames, and so on.

1. A video decoding method for the decompression of an input coded bitstream corresponding to an original video sequence that had been divided into successive groups of frames (GOFs) and coded by means of a subband video coding method comprising, in each GOF of said sequence, at least the following steps:
a temporal filtering step, performed on each successive couple of frames;
a spatial analysis step, performed on said filtered sequence;
an entropy coding step, performed on said analyzed, filtered sequence, the coded bitstream thus generated being organized in n sub-bitstreams that respectively correspond to the subbands usefull at the decoding side to reconstruct the first couple of frames of the current GOF and, successively, the (n−1) other couples of frames; said decoding method being characterized in that it comprises:
on the one hand, for the reconstruction of said first couple of frames of said current GOF, the sub-steps of:
decoding each current bit b of the current sub-bitstream of said coded bistream;
interpreting each decoded bit as containing a significance information related to one or several pixels in a given spatio-temporal subband or a set of such subbands;
testing the contribution of said subband(s) to the reconstruction of said first couple of frames and storing only the decoded bits that contain information related to other frames than the frames of the first couple of frames, said stored bits forming a so-called sub-sampled portion of bitstream;
reconstructing said first couple of frames;
on the other hand, for the reconstruction of said (n−1) other couples of frames of the current GOF, the sub-step of decoding the current subbands by combining the previous sub-sampled portion and the new current sub-bitstream of said coded bitstream according to the following rules:
the decoding sub-step of said previous sub-sampled portion is only carried out in order to retrieve the associated information that concerns the newly decoded subband(s);
when decoding a bit b, if it is interpreted as containing information exclusively about the newly decoded subband(s), it is stored and replaced, by means of a switching operation, by the next bit in the new current sub-bitstream of the coded bitstream;
when continuing the decoding of the bits in said new current sub-bitstream, it is switched back to the previous sub-sampled portion and its last non-decoded stored bit as soon as a bit of said new current sub-bitstream is interpreted as containing information about other subbands than the newly decoded ones;
storing simultaneously the next sub-sampled portion of bitstream, which is a combination of the bits of said previous sub-sampled portion and said new current sub-bitstream and does not include the bits that will not be needed any longer;
said decoding method being thus applied in order to reconstruct successively each couple of frames of the current GOF, up to the last one.

2. A video decoding device for the implementation of said decoding method.
